(19) United States
(12) Patent Application Publication
(10) Pub. No.: US 2014/0148194 A1
(43) Pub. Date: May 29, 2014

(54) LOCATION POSITION MOBILE DEVICE MANAGEMENT SYSTEM

(71) Applicant: LG CNS CO., LTD., (US)

(72) Inventors: Byung Hyun Ahn, Seoul (KR); Ja Yoon Kong, Seoul (KR); Yong Seock Pai, Seoul (KR); Gwang Sik Suh, Seoul (KR); Sunhaw Shim, Seoul (KR); Manho Han, Seoul (KR)

(73) Assignee: LG CNS CO., LTD., Seoul (KR)

(21) Appl. No.: 13/688,953

(22) Filed: Nov. 29, 2012

(51) Int. Cl. H04W 64/00

(52) U.S. Cl. CPC H04W 64/003
USPC 455/456.1

(57) ABSTRACT

Embodiments described herein provide approaches relating generally to location position management of mobile devices. Specifically, a mobile device management system is provided for determining a location of a mobile device using wireless communications equipment and controlling the mobile device based on the location.

### BACKGROUND

1. Technical Field

The present invention relates generally to location position management of a mobile device and, more particularly, to a mobile device management system for determining a location of a mobile device using wireless communications equipment and controlling the mobile device based on the location.

2. Related Art

Nowadays, wireless communication devices are equipped with various enhanced features to identify its current geographical location. Examples of wireless communication devices include mobile devices such as cell phones, laptops, and personal digital assistants (PDA). Many wireless communication devices, for example mobile devices, are equipped with global positioning system (GPS) navigators to identify its current location. Hence, a mobile device in the wireless communication network, upon receiving a request to find its coordinates or current geographical location, automatically switches on the GPS module for resolving geographical bearings.

Another method to identify a current location is the use of the Wi-Fi triangulation method and Bluetooth triangulation method. In this method, the location of a particular Wi-Fi base station to which the mobile device is currently associated is identified. However, one challenge lies in clearly identifying the physical location of the mobile device, whether the physical location is indoors or outdoors of a building. Also, several additional problems in current geo-location technologies exist. The power consumption at a GPS receiver is always one of the major concerns in view of the portability of the mobile unit. The more data processed at the receiver, the more profound the problem. Having a GPS receiver receive plural signals and then calculate its position requires extensive processing power.

U.S. Pat. No. 7,532,158 describes a system and method for locating mobile devices using location information received from a mobile device to be located, wherein the information may include GPS-related information and/or path length information with respect to one or more signals transmitted by network elements.

U.S. Pat. No. 7,599,796 describes a dual mode location positioning system that comprises multiple wireless or wired network communication devices, one of the multiple network communication devices including a GPS receiver.

United States Patent Application US20110312337 describes a method for identifying location of a mobile device in a wireless communication network that includes identifying Hierarchical Cell Structure (HCS) priority number of a cell in which the mobile device is currently located.

United States Patent Application No. US20080231499 describes providing a mobile phone device that includes a global positioning system (GPS) module that allows the mobile phone device to be located by a third party device using a location query methodology.

U.S. Pat. No. 6,204,808 discloses a system that receives assistance information developed from ephemeris data via a wireless network to determine the location of a mobile station.

Therefore, what is needed is a solution that addresses at least one of the deficiencies of the current art.

### SUMMARY

In general, embodiments described herein provide approaches relating generally to location position management of mobile devices and, more particularly, to a mobile device management system for determining a location of a mobile device using wireless communications equipment and controlling the mobile device based on the location.

One aspect of the present invention includes a method for managing a mobile device in a mobile device management system (MDMS), the method comprising the computer-implemented steps of: receiving a wireless identifier associated with a wireless equipment device; determining a policy associated with the wireless identifier; and applying the policy to a mobile device.

Another aspect of the present invention provides a mobile device management system for managing a mobile device, comprising: a receiver component configured to receive a wireless identifier associated with a wireless equipment device; a policy component configured to determine a policy associated with the wireless identifier; and the policy component further configured to apply the policy to a mobile device.

Another aspect of the present invention provides a computer-readable storage medium storing computer instructions which, when executed, enables a computer system to manage a mobile device in a mobile device management system (MDMS), the computer instructions comprising: receiving a wireless identifier associated with a wireless equipment device; determining a policy associated with the wireless identifier; and applying the policy to a mobile device.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a representation of a wireless communication equipment network diagram according to illustrative embodiments;

FIGS. 2-3 show a first representation of an exemplary mobile device management system (MDMS) implementation according to illustrative embodiments;

FIGS. 4-5 show a second representation of an exemplary mobile device management system (MDMS) implementation according to illustrative embodiments; and

FIG. 6 shows an operational flow chart for providing a mobile device management system (MDMS) according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments now will be described more fully herein with reference to the accompanying drawings, in which exemplary embodiments are shown. Embodiments described herein provide approaches relating generally to location position management of mobile devices and. more particularly, to a mobile device management system for determining a location of a mobile device using wireless communications equipment and controlling the mobile device based on the location.

It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

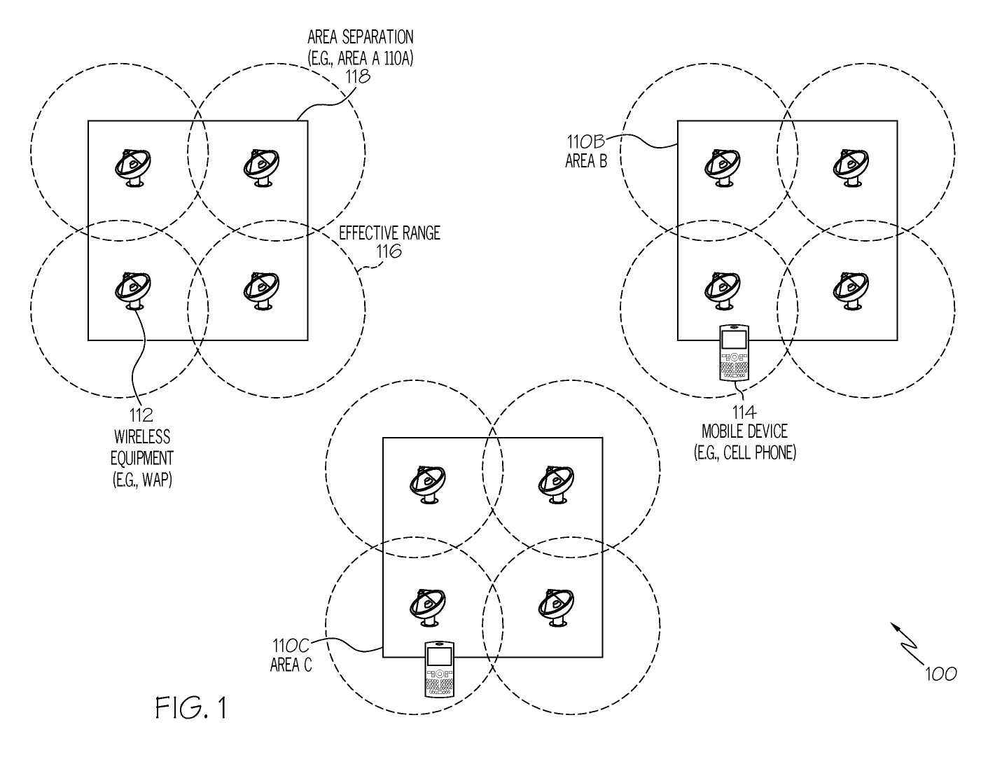

Referring now to FIG. 1, a representation of a wireless communication equipment network diagram 100 in which aspects of the illustrative embodiments may be implemented is shown. Three separate wireless areas are shown: Area A 110A, Area B 110B, and Area C 110C. A boundary for each respective area is illustrated (e.g., area separation 118 depicts the boundary for Area A 110A). Each area may include one or more pieces of wireless equipment. In this example, each respective area contains four separate pieces of wireless equipment (e.g., wireless equipment 112). Wireless equipment 112 may be operable to communicate with one or more cooperating mobile devices through a communications interface (e.g., a wireless application protocol (WAP) communications interface). Mobile device 114 is shown with the boundary of Area B 110B. Mobile device 114 may include a smart phone, cell phone, personal digital assistant (PDA), laptop, or the like, that is operable within a wireless communication environment.

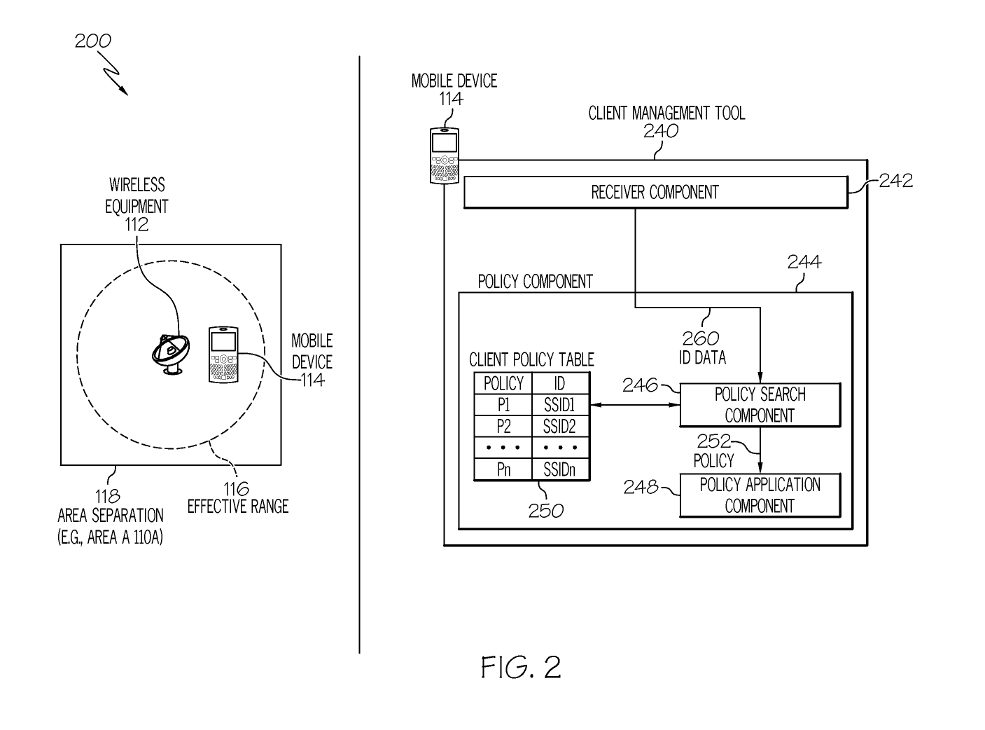

Referring now to FIG. 2, a representation of a first exemplary mobile device management system (MDMS) implementation 200 is shown. As depicted, implementation 200 includes mobile device 114 having client management tool 240 operating within Area A 110A. Wireless equipment 112 has an effective range 116. Effective range 116 is the farthest range to which wireless equipment 112 can be expected to communicate with a mobile device or other equipment. Mobile device 114 is shown within the effective range 116 of wireless equipment 112. The boundary for Area A 110A is shown by area separation 118.

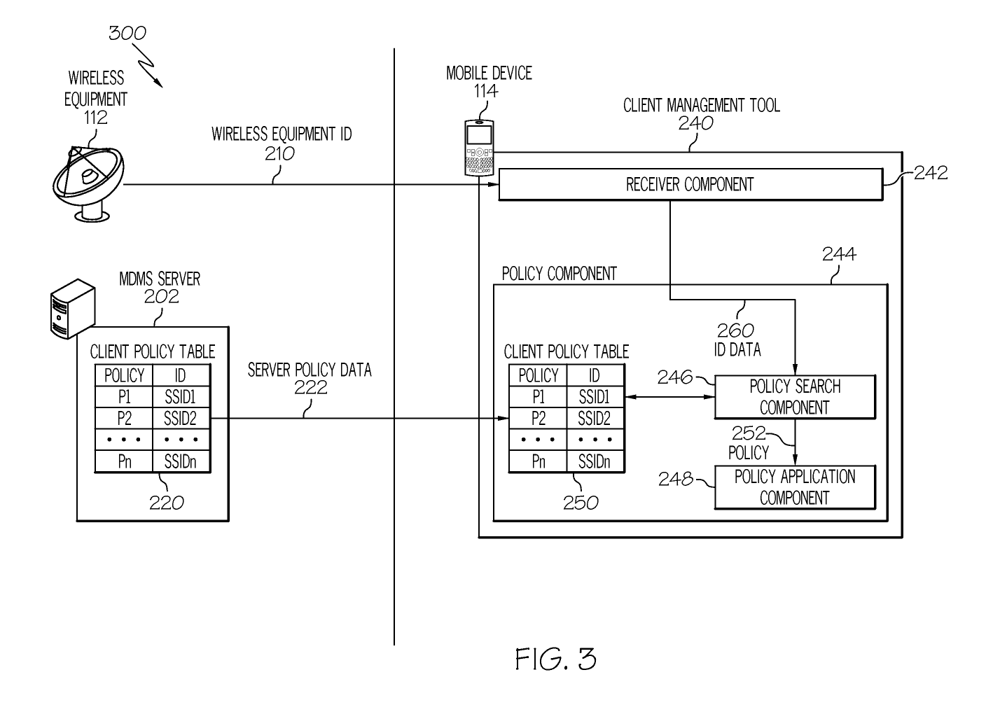

Mobile device 114 includes client management tool 240. Client management tool 240 includes receiver component 242 and policy component 244. Policy component 244 includes client policy table 250, policy search component 246, and policy application component 248. The operation of wireless equipment 112 and mobile device 114 is described in greater detail in FIG. 3.

Referring now to FIG. 3, a representation of the first exemplary mobile device management system (MDMS) implementation 300 according to illustrative embodiments is shown in greater detail. Implementation 300 is intended to represent any type of MDMS system that may be implemented in deploying/realizing the teachings recited herein. FIG. 3 depicts wireless equipment 112 and mobile device 114, similar to FIG. 2. Mobile device 114 includes client management tool 240 having receiver component 242 and policy component 244. Policy component 244 includes client policy table 250, policy search component 246, and policy application component 248.

FIG. 3 further includes MDMS server 202. MDMS server 202 provides the ability to manage any number of mobile devices. MDMS server 202 may provide mobile device management (MDM) software capable of providing an information technology (IT) department of a business or enterprise the ability to securely enroll mobile devices in an enterprise environment, wirelessly configure and update settings, monitor compliance with corporate policies, and remotely wipe or lock managed devices. With mobile devices becoming ubiquitous and applications flooding the market, mobile monitoring is growing in importance.

MDMS server 202 includes server policy table 220. Server policy data 222 may be used to populate and/or update client policy table 250. In one example, server policy data 222 is pre-loaded onto the mobile device 114. In addition, client policy table 250 may be periodically updated via server policy data 222 when one or more changes are made to server policy table 220. As shown, server policy data 220 and client policy table 250 contain two columns of data: policy data (e.g., P1, P2, etc.) and ID (e.g., SSID1, SSID2, etc.). Each ID corresponds to a wireless equipment identifier related to a particular area. A wireless equipment identifier is used to retrieve related policy data associated with a particular area. The number of rows may equal the total number of predefined areas. For example, FIG. 1 depicts three areas (i.e., Areas A, B, and C). Therefore, server policy data 220 will contain three rows of policy data. A given policy, when applied to a mobile device 114, may determine the access capabilities and/or access restrictions of the mobile device 114 while the mobile device is within the respective area.

Wireless equipment (e.g., wireless equipment 112) within an area (e.g., Area A 110A) may have an area identifier (e.g., wireless equipment ID 210) that is unique to that area. An identifier is used to distinguish one area from another. Each geographic location, such as a business or enterprise, may be divided into any number of “areas”, with each area being assigned a unique identifier representing the respective area. Referring back to FIG. 1, consider an example in which a business is divided into three areas: Area A 110A, Area B 110B, and Area C 110C. The four wireless equipment devices in Area A 110A will have an identifier (e.g., AreaA), the four wireless equipment devices in Area B 110B will have an identifier (e.g., AreaB), and the four wireless equipment devices in Area C 110C will have an identifier (e.g., AreaC). The assigned identifier will be unique within the location (i.e., the business) and unique to each respective area. An identifier may be a unique number, symbol, character, character string, or any combination thereof.

The wireless equipment ID 210 is received at the mobile device 114 via the receiver component 242 of the client management tool 240. In one example, the wireless equipment ID 210 is transmitted to (or “pushed”) to the mobile device 114 after the wireless equipment 112 detects the mobile device 114. In another example, the mobile device 114 searches for nearby wireless equipment and detects wireless equipment 112. The mobile device ID 210 then retrieves the wireless equipment ID 210 from the wireless equipment 112

After the wireless equipment ID 210 is received at receiver component 242, it is transmitted to the policy search component 246. The policy search component 246 searches the client policy table 250 for a match using the wireless equipment ID 210. The search may be performed by performing a table lookup operation based on the wireless equipment ID 210. If a match of the wireless equipment ID 210 is found, the policy 252 associated with the wireless equipment ID 210 is transmitted to the policy application component 248. The policy application component 248 applies the policy 252 to the mobile device 114. In one example, a default policy may be applied when a match is not found in the client policy table 250. The policy data allows for managing or controlling the mobile device 114. For example, the policy data may be operable to: securely enroll the mobile device 114 in an enterprise environment, limit access of the mobile device 114, wirelessly configure and update settings, monitor compliance with corporate policies, remotely wipe or lock the mobile device 114, or any other appropriate management or security function.

For example, the mobile device 114 enters an area (e.g., Area B 110B). The wireless equipment 112 located in Area B 110B has a wireless equipment ID 210 of “SSID2”. In FIG. 3, the wireless equipment ID 210 (i.e., ID data 260) is received by receiver component 242. In one example, ID data 260 may include other information in addition to the wireless equipment ID 210. A lookup function is performed on the client policy table 250. Using “SSID2” as the example wireless equipment ID 210 value, the policy data “P2” is retrieved from the client policy table 250. The policy “P2” (i.e., policy 252) is sent to policy application component 248. Policy “P2” is applied to the mobile device 114.

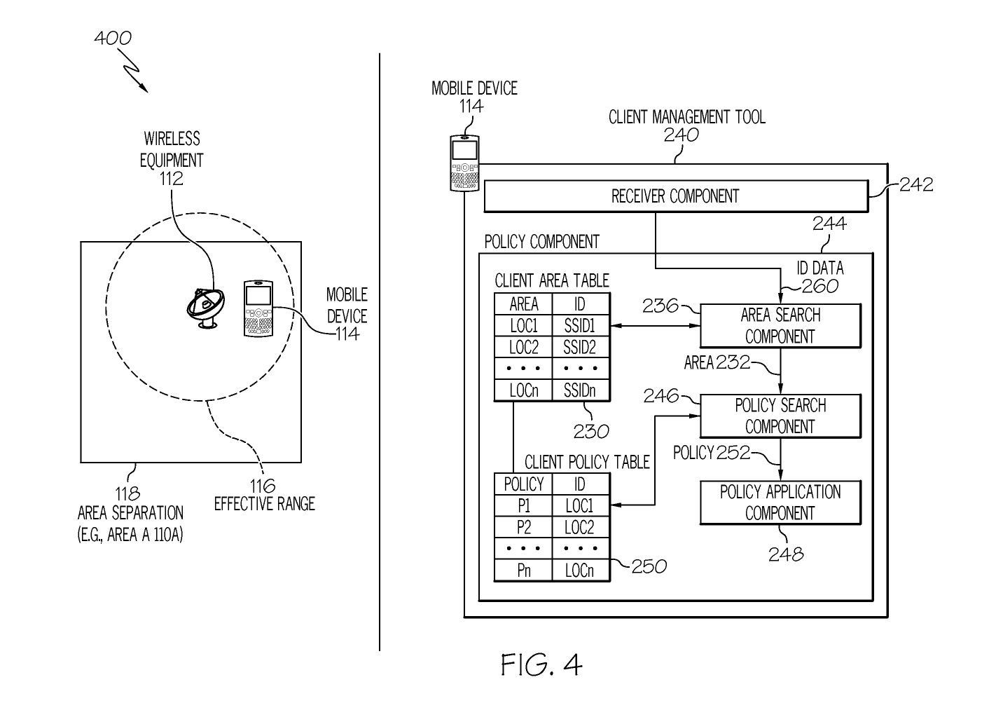

Turning now to FIG. 4, a representation of a second exemplary mobile device management system (MDMS) implementation 400 is shown. As depicted, implementation 400 includes mobile device 114 having client management tool 240 operating within Area A 110A. Wireless equipment 112 has an effective range 116. Mobile device 114 is shown within the effective range 116 of wireless equipment 112. The boundary for Area A 110A is shown by area separation 118.

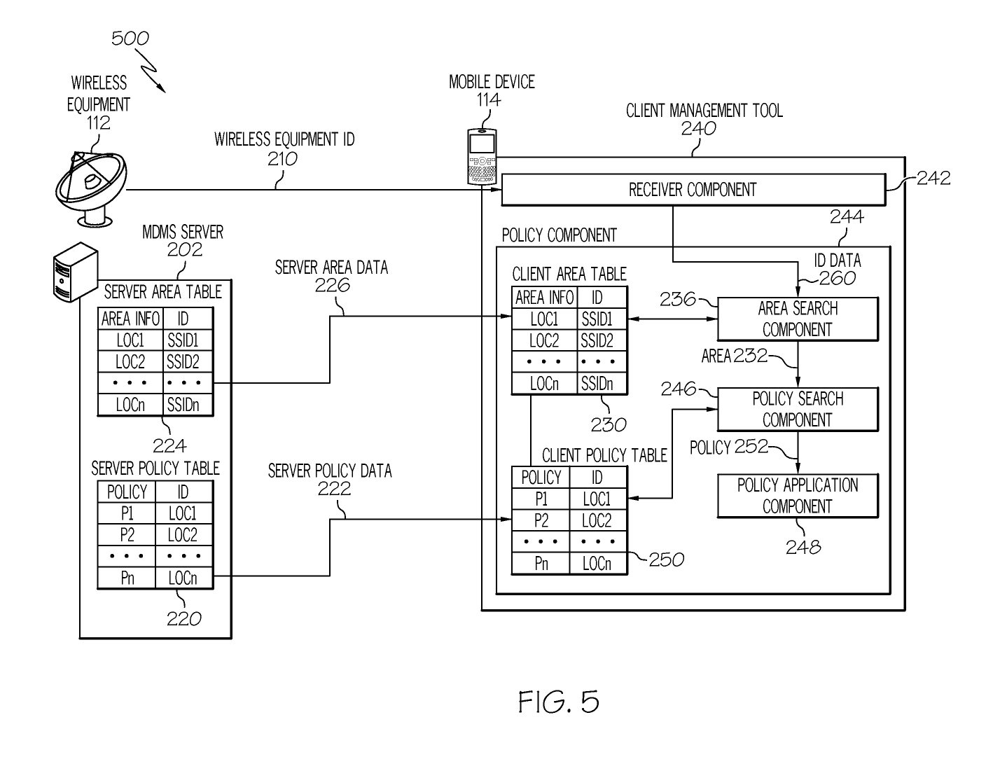

Mobile device 114 includes client management tool 240. Client management tool 240 includes receiver component 242 and policy component 244. Policy component 244 includes client area table 230, client policy table 250, area search component 246, policy search component 246, and policy application component 248. The operation of wireless equipment 112 and mobile device 114 is described in greater detail in FIG. 5.

Referring now to FIG. 5, a representation of the second exemplary mobile device management system (MDMS) implementation 500 according to illustrative embodiments is shown in greater detail. Implementation 500 is intended to represent any type of MDMS system that may be implemented in deploying/realizing the teachings recited herein. FIG. 3 depicts wireless equipment 112 and mobile device 114, similar to FIG. 2. Mobile device 114 includes client management tool 240 having receiver component 242 and policy component 244. Policy component 244 includes client policy table 250, policy search component 246, and policy application component 248.

FIG. 5 further includes MDMS server 202 which provides the ability to manage any number of mobile devices, which may include, among other things, the ability to wirelessly configure and update settings, monitor compliance with corporate policies, and remotely wipe or lock managed devices. Wireless equipment (e.g., wireless equipment 112) within an area (e.g., Area A 110A) [not shown on the drawing] has an associated area identifier (e.g., wireless equipment ID 210) that is unique to that area. The area identifier is used to distinguish one area from another.

The wireless equipment ID 210 is received at the mobile device 114 via the receiver component 242 of the client management tool 240. After the wireless equipment ID 210 is received at receiver component 242, it is transmitted to the area search component 236. The area search component 236 searches the client area table 230 for a match using the wireless equipment ID 210. If a match of the wireless equipment ID 210 is found, the area 232 (i.e., location of mobile device) associated with the wireless equipment ID 210 is transmitted to the policy search component 246. The policy search component 246 searches the client policy table 250 using the area 232 that was retrieved from the client area table 230. If a match of the area 232 is found, the policy 252 is sent to the policy application component 248. The policy application component 248 applies the policy 252 to the mobile device 114. In one example, a default policy may be applied when a match is not found in the client area table 230 and/or the client policy table 250.

For example, in FIG. 5, the mobile device 114 enters an area (e.g., Area A 110A). The wireless equipment in Area A 110 has a wireless equipment ID 210 of “SSID1”. The value “SSID1” (i.e., ID data 260) is received by receiver component 242. A lookup function is performed on the client area table 230. Using “SSID1” as the wireless equipment ID 210 value, the value “LOC1” is retrieved from the client area table 230. The “LOC1” value (i.e., area 232) is received by policy search component 246. The table lookup function is performed on client policy table 250 using “LOC1”. The policy “P1” (i.e., policy 252) is retrieved from the client policy table 250 and sent to policy application component 248. Policy “P1” is applied to the mobile device 114.

In one example, client area data and client policy data may be stored in one or more tables. For example, FIGS. 2-5 depict client area data stored in table 230 and client policy data stored in client policy table 250. Each table may consist of rows of data values or keys in labeled and typed columns. In another example, client area data and/or client policy data may be stored using a different database structure.

MDMS server 202 includes server area table 224 and server policy table 220. Server area data 226 may be used to populate and/or update client area table 230. Server policy data 222 may be used to populate and/or update client policy table 250. In one example, server area data 226 and server policy data 222 are pre-loaded onto the mobile device 114. In addition, client area table 230 and/or client policy table 250 may be periodically updated when one or more changes are made to the respective server table.

As shown, server area table 224 and client area table 230 contain two columns of data: area information and ID. Each ID corresponds to a wireless equipment identifier related to a particular area. The number of rows may equal the total number of predefined areas. For example, FIG. 1 depicts three areas (i.e., Areas A, B, and C). Therefore, server area data 220 will contain three rows of area data. A wireless equipment identifier is used to retrieve an area location value. Also, server policy data 220 and client policy table 250 contain two columns of data: policy data (e.g., P1, P2, etc.) and ID (e.g., SSID1, SSID2, etc.), as described in FIG. 3.

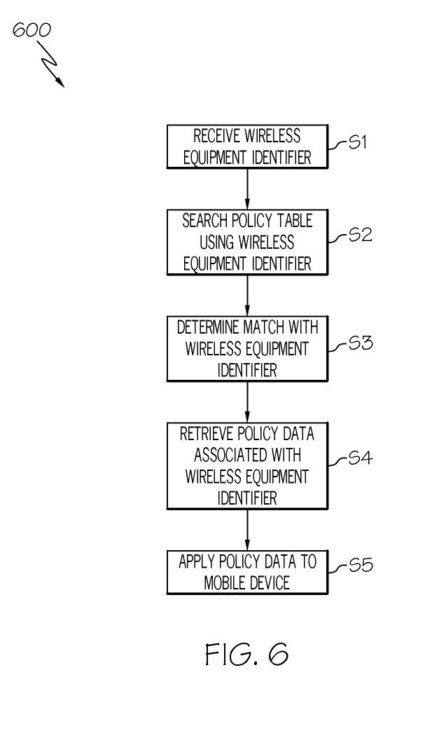

Referring now to FIG. 6, an exemplary process flow diagram for providing a mobile device management system (MDMS) according to illustrative embodiments is shown in greater detail. As shown, at S1, a wireless equipment identifier (ID) is received when a mobile device enters a predefined area. At S2, a policy table is searched using the wireless equipment ID. At S3, a match of the wireless equipment ID is determined. At S4, policy data associated with the matched wireless equipment ID is retrieved. At S5, the policy data is applied to the mobile device. Using this method, the mobile device may be managed and controlled based on the area the mobile device is in. For example, referring back to FIG. 1, when mobile device enters Area A 110A, a policy associated with Area A 110A will be applied to the mobile device. If the mobile device is moved from Area A 110 A to Area B 110B, a policy associated with Area B 110B will be applied. A company or enterprise may wish mobile device usage to be more restrictive in Area B 110B than Area A 110A. Therefore, a more restrictive policy may be applied when the user device enters Area B 110B from Area A 110 A. Again, this allows for location-based management of the mobile device. In certain embodiments, the steps described above may be performed concurrently or in a different order than shown.

While shown and described herein as a unified transportation payment solution, it is understood that the invention further provides various alternative embodiments. For example, in one embodiment, the invention provides a computer-readable/useable medium that includes computer program code to enable a computer infrastructure to provide financial transaction record generation functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a computer-implemented method for applying policy data to a mobile device. In this case, a wireless infrastructure, such as implementation 100 (FIG. 1), can be provided and one or more systems for performing the processes of the invention can be obtained (e.g., created, purchased, used, modified, etc.) and deployed to the wireless infrastructure. To this extent, the deployment of a system can comprise one or more of: (1) installing program code on a mobile device, from a computer-readable medium; (2) adding one or more computing devices to the wireless infrastructure; and (3) incorporating and/or modifying one or more existing systems of the wireless infrastructure to enable the wireless infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for managing a mobile device in a mobile device management system (MDMS), the method comprising the computer-implemented steps of:
receiving a wireless identifier associated with a wireless equipment device;
determining a policy associated with the wireless identifier; and
applying the policy to a mobile device.

2. The method of claim 1, further comprising:
predefining an area; and
assigning a wireless identifier to a wireless equipment device within the area;

3. The method of claim 1, wherein the policy defines an access restriction.

4. The method of claim 1, wherein the step of determining the policy comprises performing a table lookup of a client policy table based on the wireless identifier.

5. The method of claim 1, wherein the step of determining the policy comprises:
performing a first table lookup of a client area table lookup based on the wireless identifier; and
performing a second table lookup of a client policy table lookup based on the first table lookup.

6. The method of claim 4, wherein the client policy table is updated from a server policy table.

7. The method of claim 5, wherein the client area table is updated from a server area table.

8. A mobile device management system for managing a mobile device, comprising:
a receiver component configured to receive a wireless identifier associated with a wireless equipment device;
a policy component configured to determine a policy associated with the wireless identifier; and
the policy component further configured to apply the policy to a mobile device.

9. The system of claim 8, wherein the wireless identifier is assigned to the wireless equipment device based on a predefined area, the wireless equipment device being located within the boundaries of the predefined area.

10. The system of claim 8, wherein the policy defines an access restriction.

11. The system of claim 8, wherein the policy component is further configured to determine the policy by performing a table lookup of a client policy table based on the wireless identifier.

12. The system of claim 8, wherein the policy component is further configured to determine the policy by performing a first table lookup of a client area table lookup based on the wireless identifier and performing a second table lookup of a client policy table lookup based on the first table lookup.

13. The system of claim 12, wherein the client policy table is updated from a server policy table.

14. The system of claim 12, wherein the client area table is updated from a server area table.

15. A computer-readable storage medium storing computer instructions which, when executed, enables a computer system to manage a mobile device in a mobile device management system (MDMS), the computer instructions comprising:
receiving a wireless identifier associated with a wireless equipment device;
determining a policy associated with the wireless identifier; and
applying the policy to a mobile device.

16. The computer-readable storage medium according to claim 15, wherein the policy defines an access restriction.

17. The computer-readable storage medium according to claim 15, the computer instructions for determining the policy comprising performing a table lookup of a client policy table based on the wireless identifier.

18. The computer-readable storage medium according to claim 15, the computer instructions for determining the policy comprising performing a first table lookup of a client area table lookup based on the wireless identifier and performing a second table lookup of a client policy table lookup based on the first table lookup.

19. The computer-readable storage medium according to claim 17, wherein the client policy table is updated from a server policy table.

20. The computer-readable storage medium according to claim 18, wherein the client policy table is updated from a server policy table and the client area table is updated from a server area table.
